(19) United States
(12) Patent Application Publication
(10) Pub. No.: US 2003/0167202 A1
(43) Pub. Date: Sep. 4, 2003

(54) Methods of payment for internet programming

(76) Inventors: Michael B. Marks, South Orleans, MA (US); Joel Marks, Sherman Oaks, CA (US)

Correspondence Address: Brad I. Golstein, Metro 88, 20755 Plummer Street, Chatsworth, CA, 91311, US

(21) Appl. No.: 09/906,718

(22) Filed: Jul. 18, 2001

Related U.S. Application Data
(60) Provisional application No. 60/219,615, filed on Jul. 21, 2000.

(51) Int. Cl. G06F 17/60

(52) U.S. Cl. 705/14

(57) ABSTRACT

User selectable methods are disclosed for paying for programming provided in association with an affiliate network operator. A playtime account is assigned to a user, a tuner or a device to track the cost of programming used and payments to cover the cost thereof. Use of a tuner causes depletion in value of the playtime account. Various means of payment are disclosed including audio/video commercials within the programming, email ads delivered in a separate time and space or situation from the programming, benefits for purchases and survey responses, and subscription fees. A user may select a level of identity in receiving advertising, including anonymous receipt of programming, resulting in a user selectable level of ad targeting. A feature of the invention is to acknowledge the value of a user disclosed identity and to compensate the user in proportion to that disclosure with predictably valuable programming services. In contrast with prior art email advertising, a user is specifically compensated with services for receiving email ads. A higher identity level allows higher value targeted ads to be sent to pay for programming, whereby an ad multiplier enhances the value of additions to the playtime account. Fewer ads are thus required with the ad multiplier enabled by targeted ads. For email ads programming may be entirely commercial-free since the ads are not received as a component of the programming. The payment methods of the invention may be used in combination either by request or by default. The playtime account is used to track debits and credits.

### FIELD OF THE INVENTION

The present invention pertains to methods of payment for programming. More precisely the present invention relates to creation of a personal account to pay for programming by non-cash methods.

### BACKGROUND OF THE INVENTION

The provision of audio/visual entertainment and information (“infotainment”) programming to an audience incurs costs for royalty payments, personnel, transmission infrastructure and other operating costs. The majority of today's commercial Infotainment media providers use advertising as the primary means for earning income to pay for such costs and generate profits. Some providers alternatively use subscription fees or pay-per-use. For 2001, Sirius Satellite Radio and XM Satellite Radio plan the introduction of subscription-supported, advertising-free audio content, supplied to users by means of satellite direct broadcast. Audio programming is increasingly being supplied through Internet connections as audio streams and similar methods. Some cable companies include music channels along with television programming as part of a subscription service.

Unlike terrestrial broadcast technologies, the transmission costs for Internet media (streaming fees and other bandwidth related charges) are proportional to audience size. When Internet media are delivered to wireless devices, wireless delivery charges add further to proportional costs (a method for offsetting such costs is disclosed in Provisional Patent Application #60/151,298 by Marks and Lipman entitled, “Business Model for Offsetting Wireless Voice and Data Communications Service Fees”). It is important therefore for an Internet infotainment provider to generate income in direct proportion to its audience size.

The Internet has enabled ads to be tailored or targeted to specific users or groups of users. This is possible by tracking what a user is doing on the Internet. A further way to target ads is for the user to provide personal preference information.

E-mail has become a well-established method for Internet advertising. U.S. Pat. No. 6,014,502 by Moraes, assigned to Juno Online Services LP discloses an example of this advertising method. In preferred embodiments, the advertising is targeted to a user. U.S. Pat. No. 5,918,014 by Robinson, assigned to Athenium, L.L.C. discloses a means of automated collaborative filtering that may be used for such targeting. The advertising message may be contained within the text of the e-mail itself or it may come in the form of an attachment.

E-mail is a personal and professional communications medium; Internet mores frown upon the use of untargeted advertising known as “spam”. Therefore, advertisers wishing to utilize this medium may ask a user's permission by offering a means for opting in or opting out of receiving such advertising. Targeted “opt-in” e-mail advertising offers the greatest benefits with the least intrusion. The targeting can be highly precise if the advertiser utilizes personal profile information and/or collaborative filtering technologies. In theory a single user can be targeted for a single ad. Targeting enables a user (the recipient) to receive advertising that is relevant to him or her. Opting-in (or out) gives the user control. Provisional Patent Application #60/192,339 by Marks and Marks entitled, “Internet Radio Device and System,” discloses a method for opting in and out of audio advertising. Provisional Patent Application by Marks and Marks filed Jun. 8, 2000 and entitled, “Opt-In Electronic Mail Advertising for Internet Radio Network,” discloses a method for opting in to receive e-mail advertising in lieu of paying subscription fees.

Goldhaber (U.S. Pat. No. 5,794,210) discloses an attention brokerage to track a user's preferences through advertising. A user may receive benefits for paying attention to advertising. The operator of the benefits program may create the list of targeted advertising. A user provides his identity to the operator. To receive benefits for viewing advertising the user logs in to the benefits program web site or otherwise enables his identity to be established. Goldhaber does not anticipate audio/video or wireless Internet applications.

Similarly, Storey (U.S. Pat. No. 5,774,870) discloses a method for providing incentives to users who shop online. A user may enroll in the incentive program at a given web site. The given web site and affiliated web sites may then award credits in the form of award points when the user purchases products.

Provisional Patent Application No. 60/169,756 by Marks and Marks entitled, “Method for Providing Incentives for Advertising Delivered via Internet Wireless and Voice” discloses another method for providing incentives in anticipation of Internet media applications.

Relevant to the present invention with regard to targeting advertising are disclosures made by Angles (U.S. Pat. No. 5,933,811) and Merriman (U.S. Pat. No. 5,948,061)

The following Provisional Patent Applications disclose methods relevant to the present invention and are fully incorporated herein: 1) Application #60/151,298 by Marks and Lipman entitled, “Business Model for Offsetting Wireless Voice and Data Communications Service Fees”; 2) Application #60/169,756 by Marks and Marks entitled, “Method for Providing Incentives for Advertising Delivered via Internet Wireless and Voice”; 3) Application # 60/164,354 by Marks, Marks and Lipman entitled, “Method for Delivery and Organization of Information Oriented by Location of Cellular Transceivers”; and 4) Application filed May, 9, 2000 by Marks and Marks entitled, “Bidding Method for Internet/Wireless Advertising and Priority Ranking in Search Results”.

Terrestrial Broadcast Radio, TBR, provides limited targeting where the audience is defined by the station genre or format. For example, at its most targeted, a Country music station might advertise concert tickets for Country singer Randy Travis or a new sort of horse shampoo. The TBR Country station has no way of knowing if a given listener likes Randy Travis or owns a horse. By contrast, an Internet Radio station (“IR”) may track a user's Internet listening and viewing habits, or receive preference information from the listener, and come to know such things. Thus the IR station may deliver better-targeted advertising than the TBR station.

Audio advertising inserted into programming is commonly used by TBR to pay for content. IR stations such as Discjockey.com, Launch.com and Netradio.com, typically use a combination of methods including audio advertising, banner advertising and e-commerce to pay for content.

Audio advertising interrupts programming. Reducing or eliminating such advertisements can be desirable. A user wishing to avoid such advertising typically changes channels. Users seeking content free of advertising interruptions may therefore be willing to pay fees in the form of subscriptions. Another type of fee for program service is to provide a radio station or associated entity with personal information to enable targeted ads to be delivered to the listener.

### SUMMARY OF THE INVENTION

The present invention provides a means for a listener to select how or whether ads are delivered in association with audio/visual programming. According to a first option an unidentified user selects an audio/visual stream and is presented with conventional audio/visual ads or commercials that accompany the programming. In a second option the user may provide personal information to enable delivery of targeted ads. The targeted ads may be in the form of commercial audio/visual interruptions. In this case the number and frequency of ads may be greatly reduced since the targeted ads will command a higher value from advertisers than ads that are broadcast without targeting. The targeted ads may further be in the form of email messages sent to a user's email address. The email ads may be delivered at a time and in a space that is disconnected from the user's audio/visual experience. In this way the audio/visual programming is not interrupted by commercial ads. Email ads are preferably targeted, however a user may opt to receive lower value non-targeted email ads to pay for programming. Email ads may be in text form, and/or audio or visual form depending on the type of ad, the receiving device and possible attachments to the email ad.

According to a preferred embodiment of the invention the audio/visual content is offered by a network of affiliated content providers. A user may select audio/visual programming from an affiliate and be presented with conventional commercials. The user may register with the network and be given a choice of paying for the content by means of subscription or targeted ads, either audio/visual or email. The advertising may be targeted by use of personal profile information and/or by tracking a user's activities within the network. E-mail advertising subsequently delivered to the user may be batched by advertising subject matter and/or by network or other web site such that multiple advertising messages may be bundled within a single e-mail transmission.

A playtime account may be provided to a user or device if the user desires fewer or no commercials in the programming. The playtime account is used to track the value of programming used and the value of activities performed to pay for the programming.

### BRIEF DESCRIPTION OF THE DRAWINGS

FIG. 1 is a schematic representation of play-lists corresponding to different user payment methods.

FIG. 2 shows the respective cost per hour for the exemplary payment methods of FIG. 1.

FIG. 3 shows a time verses playtime account value for various payment methods.

### DETAILED DISCLOSURE OF THE PRESENT INVENTION

According to the present invention a user receives audio/visual programming through a data network such as the Internet. A typical type of programming may include play-lists of music, although other programming such as news and information are included in the scope of the invention. Video programming is also covered by the scope of the invention. A radio or Internet station or other entity, referred to herein as the Station, provides or assembles the programming for presentation to a user. These Stations are affiliated as members of a network, wherein the network is at least partially overseen or controlled by a network operator. This affiliate network is distinct in function from a data network such as the Internet described above. The affiliate network operator may partly or wholly own the Stations.

When a user selects a Station's programming he may be presented with certain options for ways to pay for the programming. Programming may include such elements as audio classified ads, audio books, location finding services, voice email, chat, as well as music and news, and video if the Station is a TV station or other video program source. A default option may be that the user does not identify himself to the Station and is not tracked by the Station. This option can help differentiate Stations of the affiliate network from other IR stations where tracking typically occurs by default. Without tracking the user receives programming with general audio advertising that may be targeted only by the program format of the Station. Of course the Station could by default track the user by means of cookies installed in the user's browser. However by promising not to do so unless the user receives compensation, the Station and the associated network can earn the trust and loyalty of users. It is a feature of the invention that a user can actively choose a level of exposure to a provider in return for proportionately higher value programming.

The general ads may be similar in frequency and quantity to ads on a conventional TBR station. The cost of programming may be offset by banner ads, e-commerce, or other such information, services and products displayed on a web page. In fact some IR providers currently pay for content substantially through various forms of display advertising (banners, buttons and the like) that appear in conjunction with content. However in the case of a home audio system or wireless device such as a personal player or a car player, the options for earning income from display advertising are limited. Portable wireless devices by definition are small, and car players must minimally distract the driver. Therefore methods other than immediate visual displays are needed to efficiently generate income for audio programs on many non-PC devices.

A listener may be given options to reduce or eliminate audio commercials in a Station's programming. The concept of the invention also applies to video commercials. As an alternative to paying subscription fees or pay-per-use fees, the listener can pay for the programming by enabling the delivery of higher value advertising by means of providing personal information and/or allowing tracking. Specifically the user can give permission for the Station to use cookies to track the user's listening history. The commercials that are delivered can then be targeted to the individual user by well-known methods. Since the value of each unit of advertising is higher, the user may be promised fewer commercials overall. If the programming is paid for by audio commercials it follows that these cannot be eliminated entirely. But by greatly increasing the value of each commercial the number of such ads can be much reduced and the value of the programming time thus enhanced.

Listeners may register to create a benefit account called a “Playtime Account”. The units of value accrued in the account are called “Playtime Credits” and correspond to minutes of programming. The Playtime Credits may be in monetary, time or other units. The network operator enables the credits to be used for commercial free programming time on affiliated Stations. Each commercial received by a listener can cause one or more Playtime Credits to be accumulated in the listener's Playtime Account. These accounts may be managed by the affiliate network operator. The Playtime Accounts would normally be available only to users who have revealed their identity in some way to a Station or network operator. Playtime Credits may accumulate value by activities other than listening to commercials. Making a purchase or inquiry in response to a visual or audio ad on a Station may add value to the account. Responding to a product or other survey may add Playtime Credits to an account. Using Playtime Credits accrued by means of responding to an audio ad using an interactive function of a home stereo component, portable or car device is an example of an additional way to pay for programming that does not require a PC display.

A user who creates a playtime account will have a number or other identifying method attached to the account. A tuner or tuning device or a web site may enable the user to view the status of the account to know for example whether more ads will be sent soon. Or the user may wish to see the effect on the playtime account of a recent purchase from a Station or other participating operator. The playtime account identifier will be loaded into the tuner or other area of a PC or portable or car player for reference as the tuner is used. A user may choose to have multiple accounts to use with respective devices, although a single account could also pay for programming on different devices. As long as an account is paid for by qualifying activities such as receipt of ads, product purchases, paid fees, or survey responses, the network operator would not normally object to one person having multiple accounts.

The user may be given an option to complete a questionnaire requesting specific personal information such as home zip code, hobbies, profession, product preferences, etc. Each piece of information requested may be assigned a value corresponding to an ad multiplier that will enhance the value of Playtime Credits accrued in conjunction with advertising, e-commerce and service offerings such that the user may enjoy advertising-free (or advertising-reduced) minutes of programming time. As a user answers more questions advertising can be more precisely targeted to the user and hence more valuable; the corresponding value of the ad multiplier may grow. A higher value multiplier means that for a given time period, fewer targeted advertisements (advertisements that have been multiplied in value) will provide the same income as a greater number of non-targeted advertisements (advertisements that have not been multiplied in value). Therefore as more questions are answered the user can be promised fewer advertising interruptions within a Station's programming. The user can decide how much personal information to give and therefore by how much the commercials will be reduced. Further, since each question or set of questions can be assigned a specific ad multiplier value, the user can see a clear benefit for divulging personal information. For example, each answered question may add 10% to a multiplier value that starts at 1; answering 5 questions would thus create a multiplier value of 1.5. Alternately the multiplier is less finely graded wherein for example, answering half the questions, or a block of related questions, causes a relatively large jump in the multiplier. The multiplier value is specific to a given user or identified user device and is attached to a user's Playtime Account; thereafter the multiplier multiplies the value of Playtime Credits (associated with the receipt of advertising and other activities) added to the Playtime Account. The network operator may require a user to “refresh” the multiplier periodically either by allowing tracking of the user's activities, by requiring a user to answer a new set of targeting questions or by other means.

According to one example, a one-minute non-targeted advertisement may be worth 3 minutes of programming—an hour of listening (or viewing) would then be accompanied by 15 minutes of commercials. A one-minute precisely targeted ad may be worth 14 minutes of programming—an hour of listening (or viewing) would then be accompanied by 4 minutes of well-targeted commercials. With regard to a Playtime Account, non-targeted advertising is delivered to users that either do not have Playtime Accounts or have Accounts with assigned multiplier values of 1 (meaning they answered no questions and/or did not enable/allow tracking). In the above example, the targeted ad uses an ad multiplier of 4.667; (14 min per target ad)÷(3 min per regular ad)=4.667. A user that enables precisely targeted advertising has benefited from an ad multiplier assigned to his Playtime Account to receive 56 ad free minutes of programming per hour rather than 45 min for the untargeted user. A premise of the invention is that a given unit of programming requires a given unit of income to cover the cost of programming creation and delivery and business profit. Income may be derived from advertising and other means. When income is derived from advertising, the value of a given advertising unit grows in value when the advertising is more targeted. An advertising unit comprises an interruption in the delivery of desired or requested programming to a user. The interruption may be temporal as in a commercial break on television or radio. Alternatively, the interruption may be spatial as in a display ad in a magazine or on a web page when programming comprises printed or displayed content. As advertising becomes more targeted and the value of an ad unit rises, fewer ad units are required to generate a given unit of income. A given user receives payment by means of fewer interruptions, fewer ad units, when that user assists in targeting advertising to himself. If in a given time period a user with a Playtime Account receives ad units beyond those necessary for the provision of programming, the user may accrue Playtime Credits for use in a future time period.

The affiliate network operator may offer products for sale in conjunction with its delivery of programming or ads. Sales of products generate income that can be allocated to cover the cost of programming creation and delivery. When a user with a Playtime Account purchases a product from the affiliate network operator (or one of the affiliates) the user may earn Playtime Credits. For example, the value of Playtime Credits for product purchases may be 5 minutes of programming per dollar. A $12 purchase would thus enable an hour of commercial-free programming.

Users with Playtime Accounts may also be offered Playtime Credits as incentives for responding to surveys and the like. In accordance with benefit programs established by the network operator, the multiplier may be applied only to Playtime Credits that accrue through receipt of advertising and not from other activities. Alternately, the network operator may apply the multiplier to all Playtime Credits regardless of how they are accrued. For example the $12 purchase in the above example may provide an enhanced benefit of 4 hours of programming for an eligible well-identified user with a multiplier of 4.

Playtime Credits are depleted from a Playtime Account as a user listens to (or views) programming. When the account value reaches zero minutes, or some other minimum value: 1) the Station or the network affiliate operator is informed that the Playtime account has a minimum allowed value; 2) an advertisement is selected which corresponds to profile information the user provided, or allowed to be created by tracking, when setting up the Playtime Account; 3) the advertisement is queued by an advertisement insertion provider to be inserted into a break point in the audio/visual stream (comprising the play-list corresponding to the user); 4) the advertisement insertion provider inserts the advertisement into the media stream (the play-list of the individual listener); 5) Playtime Credits corresponding to the Playtime Credit value of the advertisement are deposited in the user's Playtime account; 6) the multiplier associated with the given account multiples the value of the eligible Playtime Credits within the Account. The particular sequence of events may vary. A playtime account may be denominated in dollars or other monetary unit, where the value relates to a cost per minute of programming. For example an account value of $5 may allow 5 hours of ad free programming if programming costs $1/hr; wherein $5÷$1/hr=5 hrs. A monetary value account may be useful if the cost of programming changes with time. In any case credits in the playtime account are convertible into playtime minutes at a current cost per minute. Likewise any program item is convertable into a cost per minute. The cost per minute may increase for example as a special item is played such as a video movie, as discussed later.

Alternate ways may be offered to add value to a Playtime Account. By subscription, a user may directly pay for service or indirectly purchase Playtime Credits that may be applied to programming service. A user may be invoiced at the end of a period for actual program minutes used. Or a user may pay a fixed fee for unlimited listening through a period. Either way there would be no commercials in the user's programming on network Stations. Subscription payment and commercial receipt payment could be used in combination. The subscription payment may be assigned a multiplier corresponding to the ad multiplier providing in effect an enhanced discount for receiving a limited amount of targeted ads.

In a related option a reverse subscription is possible wherein a user receives Playtime Credits for actions taken while listening to Stations. Such actions may include purchases from Stations or their web sites, responses to surveys of a Station or the affiliate network, or even responses to commercials. A response to a commercial may be either an active response such as a “click-thru” (clicking on a banner ad to receive additional information from the advertiser) or other action on a device to indicate interest. Or a response may be passive such as a “play-thru” wherein a user does not change Stations during the period that the commercial is being played. Click-thrus will generally indicate a heightened level of user interest and may therefore be considered particularly valuable. A played thru ad can be valued higher than an ad that was tuned out by switching stations or possibly by being muted. A tuned out or turned off ad may add little or no value to a user's playtime account and may even cause Playtime Credits to be subtracted from the Account. In contrast with a requested ad, a tuned out ad will have reduced or negative value. The quantity of value deducted from a tuned out ad may relate to the portion of the ad that was tuned out.

According to one example, the network operator may provide a cost schedule to advertisement providers wherein the cost of an advertisement is correlated to Playtime Credits such that a user (or “target”) receives one Playtime Credit for every $0.02 in advertising expenditure correlated to that particular user. Following is an example of an advertisement cost schedule and its relationship to Playtime Credits:

Advertising Cost Schedule:

| | | | |
|---|---|---|---|
| Delivery of Advertisement Per | $0.01 | 0.5 | Playtime Credit |
| Target: | | | |
| Target Click-Thru (response): | $0.50 | 25 | Playtime Credits |
| Target Play-Thru | $0.04 | 2 | Playtime Credits |
| Target Tune-Out | −$0.01 | −0.5 | Playtime Credits |

In the example above an advertisement that is delivered to a target and subsequently tuned-out costs nothing to the advertiser and causes Playtime Credits to be deducted. A user with a continuing sequence of negative credits will find increasing commercial clutter as is required to maintain the playtime account, unless other methods to pay for programming such as email or fees have been arranged or allowed. A user that tunes out all ads will thus be encouraged to select a different provider of programming.

If a target allows an advertisement to play-thru, 2 Playtime Credits are deposited into his Playtime Account. The Multiplier corresponding to the Account then multiplies those credits. For example an ad multiplier of four will enhance the two credits up to eight. If a user's multiplier is not known immediately when ads are sent to refill the playtime account, a required quantity of ads may be sent as if the multiplier is one to refill the playtime account. The multiplier then operates on the Playtime Credits after they are granted. The playtime account will then be in surplus if the multiplier is greater than one. The effect would be that more programming time can be used before the account is depleted and more ads must be sent. Alternately the multiplier operates on the credits as they are earned wherein the account is less likely to have a short term surplus since the crediting may be more immediately precise. A user that is identified by being assigned only a playtime account but not tracking or targeting will not have the credits multiplied. A user may have opted for this level of identity to allow receipt of non-targeted email as a way to pay for programming.

According to the above description audio (or video) commercials, and other associated ads, may fit in one of three categories; a requested ad with a high value, a played through ad with a standard value, and a tuned out ad with a minimal value. An audio commercial could be requested for example by responding to a visual banner ad or other audio ad. The response can be by clicking on an icon on a PC screen or operating an input feature of a specialized listening device such as a portable wireless player. The response may include a request of product samples, a request for emailed information, or a product purchase. Compensation to a user may be in forms other than Playtime Credits—the payment may be in cash or other benefit such as free or cheap CDs or other storable music files possibly related to the Station's format, or frequent flyer miles. In the same vein the network affiliate operator may provide a means whereby Playtime Credits can be converted to such alternative forms of compensation making the playtime account a general benefit program that may be related to receipt of emails ads independently of receipt of programming.

According to another option a listener may opt-in to receive email advertising. The email ads can be targeted to the extent that the user has provided personal information and/or allowed tracking to enhance the ads' value, although tracking or personalization is not required. Providing information that enables targeting of email ads will enable the user to benefit from the Playtime Account Multiplier, or ad multiplier. The email ads may be identified as originating from the Station or affiliate network. As with the targeted commercials above, a well-targeted email ad will have a higher value while a less targeted one will require more such ads to be sent to have the same value. Receiving email ads to pay for audio/visual programming provides an experience that is distinct from that of audio commercials. The ads are received in a separate time and space from the listening/viewing experience, and therefore the audio/visual programming is effectively “commercial-free”. Receipt of email ads received may accrue Playtime Credits in a user's Playtime Account. If the user has selected email ads as a payment method, one or more email ads may be sent each time the Playtime Credits in the user's Playtime Account are depleted to the assigned minimum value. The sending of emal ads is linked to the user's receipt of programming by tracking the value of the Playtime Account. This minimum value may change with time. As Playtime Credits are entered into the user's Account the Account's Multiplier may multiply them. E-mail ads are especially desirable as a non-visual option when display type ads are not appropriate or not possible, as with a portable wireless audio or car player. Email ads may be delivered to an email program on a PC, an Internet enabled wireless device or any other computerized appliance including optionally the device that is used to play programming. In this latter case the email still need not displace programming since it may be opened or read at a separate and unrelated time and situation from when programming is played. Receipt of email ads and receipt of programming which the ads serve to pay for remain disconncted in time and situation, or at least readily disconnectable. However the email ads and programming remain linked in that the email ads are sent in reaction to or in relation to the receipt of programming.

A user may be offered a trial period where reduced or commercial-free programming, also referred to here as “valuable programming”, is available for a limited time period or in a limited form on personal channels of Stations. This is a way to demonstrate the features of a tuner and related services that may be provided by the network operator. The trial service may be paid for by the network operator or a host web site as a way to acquire customers, with ads targeted to users who later opt-in generating operational income. For example a three hour or other length loop of music programming may be offered or available commercial-free to any non-identified users on network owned or affiliated Stations. Different Stations may offer different loops to reflect each Station's format. The loops would change infrequently if at all. An announcement may be included periodically to suggest the user sign up to opt into tracking or identification, such as providing an email address. If the user likes the three-hour loop he should be inclined to sign up. If he does not sign up, the three-hour loop would start to lose value to the user since the variety of material in the loop is limited by design. The three-hour loop may be partially customizable where a few selections can be altered within the play-list to demonstrate a customization feature if it is offered in the tuner supplied by the network operator (or supplied by the network operator as part of the network's service offerings).

A virtual tuner provided by the network operator may reside on a user's PC desktop. The tuner may be derived from that described in provisional patent application, “Audio Internet Navigation System—application #60/193,372; filed Mar. 31, 2000, wherein various affiliated Stations provide a tuner as a common user interface. The tuner need not have any banners or other directly income related visual features. Rather, use of the tuner causes depletion of Playtime Credits within the user's Playtime Account or causes email ads or other ads to be sent if sufficient Playtime Credits are unavailable to pay for delivery of programming. If the quantity of Playtime Credits accrued from receipt of email ads or other ads exceeds the quantity depleted to pay for programming, the user may accrue the resulting positive balance of Playtime Credits in his or her Playtime Account. The issuance of Playtime Credits to a user corresponds to income received by the network operator and may periodically cause funds to be transferred electronically to programming content and delivery providers. Funds sent to providers are normally accounting units separate from a user's Playtime Credits.

A virtual, visual PC based tuner that generates income indirectly as with email ads can be well-focused on providing for selecting, playing and/or modifying audio programming. The tuner need not generate income through visual displays such as banners or buy links within the tuner, nor even have links to a home page of the network operator. Moreover, tuners are typically minimized on a PC screen while a user performs other tasks—thus even tuners designed for visual advertising offer limited opportunities for delivering such advertising. Without the need to function as a visual advertising delivery mechanism a tuner can thus be compact and non-distracting (the need and/or desire to minimize the tuner will be reduced and users may gain utility from keeping the tuner immediately accessible). This makes the tuner of the present invention distinct from the prior art where the prior tuners (also known as a player e.g. Real Player), the web site of the tuner's supplier, or commercials within the audio programming are designed to generate income directly. The tuner of the present invention is thus well suited for use on third party web sites wherein the network operator provides the tuner and associated audio services as a private label feature for e-commerce or other web sites. The tuner and network operator will not compete with the host web site for the attention of the user. The host web site can offer the tuner as an added service to its users. Revenues from the email ads may be collected by the network operator, and if the user has obtained the tuner from the third party web site host the income from the ads is shared with the host.

The third party host may be a TBR Station. Such a station may insist on also including audio ads within any programming accessed by means of the tuner of the present invention since audio programming is a traditional TBR business and income source. The tuner can provide the Internet site of a TBR Station with a means for producing enhanced income if users of the site have elected to receive email ads. Possibly the TBR Station may choose to offer fewer than normal commercial interruptions in the audio stream (an improved user experience that will make the Station's Internet site more competitive) and make up for the income loss through targeted, opt-in email ads. The commercials may be separate in subject or related in subject to the email ads.

The tuner can be a physical device or component such as a wireless player, car audio system, or stereo component. This device may be obtained from the network operator or its authorized suppliers, or from the third party web site host that has private labeled the tuner. The private labeled tuner device may include a physical marking or logo showing the brand of the hosting web site or other sponsor.

It may be typical that each Station maintains a Playtime Account for a listener. Alternately there may be a single Playtime Account that accrues credits whenever a user selects an affiliated Station. The user receives advertising or engages in e-commerce or other activity that generates income for the Station and affiliate network while accessing programming from the network Station. For affiliate network owned Stations it is natural that a user's Playtime Credits can be automatically accrued or withdrawn from his or her Playtime Account during the course of listening to various network Stations. Independently owned Stations or third party web site hosts may wish to maintain unique Playtime Accounts to retain more control over the ads their listeners receive and the benefits of their listener's actions. Independent Stations or third party web sites may contract with the network operator for services such as furnishing play-lists and ads, providing a player or tuner interface, maintaining user tracking records and/or Playtime Accounts and other operational functions. The network operator could be invisible to listeners of the independent Station.

Payments for playtime can be simplified wherein only one or some of the above options are available. For example a listener may opt to receive targeted email ads. No other option may be desired or even offered by the Station, web site, or network operator. The ads may be delivered in proportion to the user's listening time, or in a simpler model, the ads are sent to the user independent of the actual listening time in return for commercial free or reduced commercial access to the Station or affiliate network Stations. In this case the ads are equivalent to an unlimited access subscription fee.

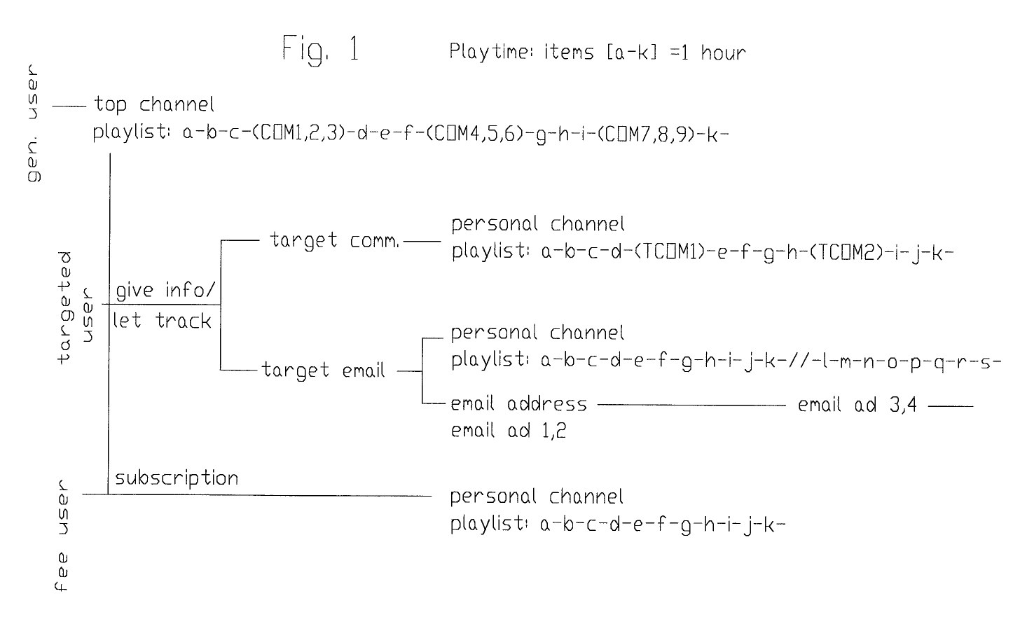

In FIG. 1 an example of some play-lists according to one embodiment of the invention are shown. A Station may offer a default channel to general users shown as Top Channel in FIG. 1. For a TBR station this may be their standard broadcast signal received directly via FM signal or converted to streaming audio for use on the Internet. An audio device may provide the ability to switch between an FM and Internet signal. If the top channel is selected and the corresponding FM signal is available to the user, the user and/or network operator may save streaming costs by using the FM signal. The network operator may provide this ability to switch signal sources. The top channel includes the Station's regular audio commercials COM (n), or other minimally targeted commercials where (n) represents a distinct commercial. The length of each ad of any type need not be always the same, i.e. different in time length or number of words.

The Station's web page or other interface may offer options for alternate channels, not shown, possibly using the tuner supplied by the network operator. These channels would normally be available only by way of the Internet. One such option may be other general interest channels that include COM (n) type commercials that are not targeted other than by the Station's format. More specialized play-lists are available in FIG. 1. Two basic types of personal channels are shown below the top channel. In one type, the “targeted user” play-list, the listener is given the option to disclose personal information and/or allow tracking of his listening, buying and other habits while listening to programming on the Station. The Station may include a promise that such tracking will occur only while the user is actually listening to the Station's programming and maybe other network affiliate Stations' programming. By providing identification or allowing tracking the user receives an ad multiplier and thus more valuable programming. This method contrasts with the prior art where a station may inform users of the station's tracking and identification policies, but does not offer not any more valuable programming in return. Further, according to the present invention the user can actively select whether to opt into being identified or tracked.

In FIG. 1 the user is presented with options for two types of targeted ads. One uses targeted audio commercials TCOM (n). These commercials are part of the play-list, but are of higher value than the less targeted COM (n) commercials of the top channel. They are therefore less frequent according to the invention.

Another type of ad is not part of a play-list. Instead it is an opt-in email ad that serves to pay for the play-list content. In FIG. 1 these email ads are sent periodically as the user continues to listen to the Station's programming. If the user does not listen, he will cease receiving the email ads. Alternately the user, Station, or network operator may choose to receive or send such ads merely for an ability to access to the Station's commercial-reduced or -free programming, independently of whether the user actually listens to the Station.

The user may request or choose to allow one or both of targeted commercials and email ads. If these are combined the frequency of each may be reduced. Rather than limiting access to one Station, receipt of targeted ads may enable the user to access personal play-lists of some or any of the network affiliated Stations. However some Stations may prefer not to “share” listeners' Playtime Accounts or equivalent records.

Personal play-lists or channels are personalized with respect to the type of advertising the user receives in association with the play-list. The programming content may be similar or identical to that of the top channel. In this case play-list items could be compiled from an FM signal and assembled at or near the user to reduce streaming costs or if Internet program streams are not available to the user. The ads may be sent by way of the Internet. However the personal channel may be further customized wherein the programming is also targeted or even unique to each user, maybe in accordance with personal play-lists disclosed in “Method for Assembly of Unique Music Playlists”—application # 60/199,120; filed Apr. 24, 2000.

An example of the method of the present invention: user Joe registers with a Station and receives a Playtime Account and accepts a cookie with his Playtime Account number into his browser (Joe's ID). Joe does not divulge any targeting information, but wishes to maintain a Playtime account to benefit from the Playtime Credits that may accrue in conjunction with his e-commerce activities within the network. Joe will therefore receive lower value, untargeted ads and the value of Joe's Playtime Account Multiplier will be 1. Joe selects a channel of popular music wherein the average song length is three minutes. The Station (or network operator) has determined that a one-minute, untargeted, audio ad generates 2 Playtime credits and that a 30 second ad generates 1 Playtime Credit; the Station or network operator has further determined that one Playtime Credit is worth 3 minutes of the current programming. Therefore Joe will need 15 credits for 45 minutes of programming. The 15 credits will come from 6 one-minute ads (2 credits each) and 3 thirty-second ads (1 credit each). The play-list includes triggers for payment action after each song. When a trigger is hit, a signal is sent to the station (or network operator) requesting delivery of either a Playtime Credit or one or more audio commercials with a value of one or more Playtime Credits. Joe's Playtime Account either pays out one credit or the advertising insertion provider delivers at least one commercial. The trigger signal includes Joe's account ID and the identity or location of the audio stream Joe is listening to thereby enabling accurate delivery of Playtime Credits and/or commercials. If the commercial(s) delivers more Playtime Credits than immediately required, the excess Credits are delivered to Joe's Playtime Account; they are then multiplied by Joe's Account Multiplier—in this case since the Multiplier value is 1 the Credits do not increase. Alternatively, when program items are coupled with ads or other credit earning items as a unit, Playtime Credits may simultaneously accrue and be depleted from Joe's account concurrent with the delivery of programming/commercial units.

Email advertising sent to Joe's email address instead of audio ad insertions may generate Playtime Credits for Joe's account. If email advertising is substituted for audio advertising insertions the time frame may be more disjointed, albeit still linked, such that a batch of email ads are sent at the end of a listening session rather than concurrent with it—in this case Joe's account will be in deficit at the end of his listening session and a quantity (or valuation) of email ads corresponding to the credit deficit in Joe's Playtime account will be sent to Joe. (Joe may also accept email advertising in advance of a listening session in which case Playtime Credits will accrue in his account). The example above also applies to any media that may be streamed and/or archived and accessed by a user.

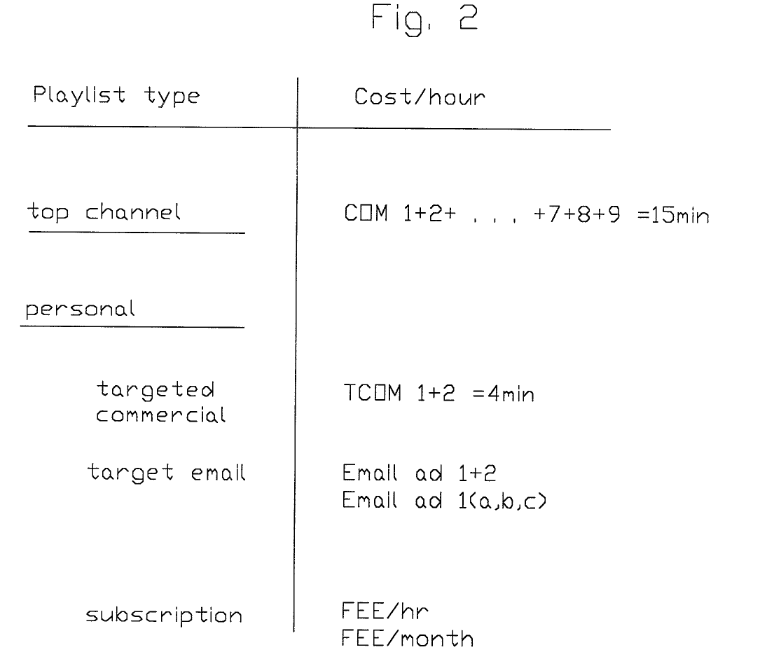

In FIG. 2 the payment amount for each type of payment method is shown. The nine commercials shown in FIG. 1 add up to 15 minutes of ads per hour in the top channel of FIG. 2. Of course more or fewer distinct commercials may comprise the example 15 minutes. In the personal channels the two targeted commercials require 4 minutes of the hour. The targeted email has no commercials in or near the programming. Instead two email ads are sent to the user's email account for each hour of listening to programming on one or more Stations. The subscription option is shown in FIG. 2 as a Fee/hour or unlimited use fee/month of programming played.

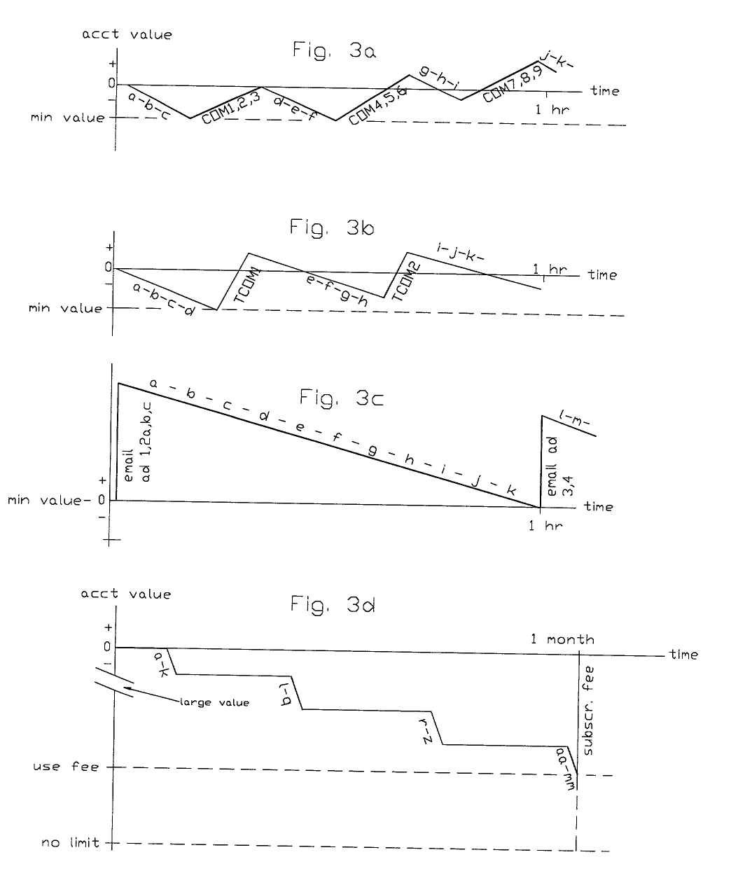

As shown in FIG. 3, the Station or network operator may allow a user's account to periodically go into deficit. This will typically happen at the beginning of a listening session when a user's account may have zero credits and the Station wishes to begin the user experience with something other than advertising. Likewise this may happen any time a unit of programming requires more credits than were available upon being served. When a Playtime Account is in deficit, the Station or network operator may deliver additional advertising to bring the Playtime Account into balance.

Regarding the email option; it is possible to break up one email ad into separate parts just as one time slot may contain one or more audio commercials. However with email the expanded number of ads need not add to the apparent clutter of incoming email. This is because multiple email ads can be bundled together under one title or subject heading. This is shown in FIG. 2 as email ad 1(a,b,c). Here one subject contains three separate messages. While two entire separate ads, email ads 1+2, pay for one hour of programming, in FIG. 2 three bundled ads, a,b, & c, are required to pay for the same hour. It would be reasonable that one bundled ad under a parent subject would represent less value than a stand-alone ad under its own subject. But such an ad would likely also cost its sponsor less than the stand-alone ad. The size or length of a bundled ad may be required to be less than a stand-alone ad to keep total length under the parent heading reasonable. Related ads may be bundled together for easy reference.

The user may appreciate an advantage when receiving bundled email ads since fewer items need clutter the inbox to provide the same playtime value as a reference number of stand alone email ads. Although the total amount of advertising text received may be similar in both cases the apparent amount of advertising can seem to be less with the bundled ads. Bundled ads further provide a lower cost way for sponsors to reach more customers. Email ads may be received on a PC or other email device while valuable programming is received on an associated but separate audio device such as a personal or car player. In all the above examples the ad times, quantity or specific values are for example only.

FIG. 3 shows exemplary playtime accounts values versus time for various payment methods. The account value decreases as programming is played, shown as a downward angle or slope of the value line. The value increases as payments are made, whereby the value line angles upward. As discussed before, the payments may be by receipt of audio commercials, FIGS. 3a and 3b. The payment can be by receipt of email ads, FIG. 3c. The payment can be by periodic direct fee, FIG. 3d.

In FIG. 3a, minimally targeted commercials COM (n) are shown. These users have typically not opted into any type of tracking or identification. The commercial breaks are relatively frequent and lengthy, with the hour including three relatively long commercial breaks. The upward slope of the value line is shallow for COM (n) type ads; meaning that a long ad set is needed to raise the playtime account value a given amount. In FIG. 3b the ads are targeted TCOM (n) type. They are of high value, so the value line is steeper upward for the ads of FIG. 3b and hence the ad breaks are shorter to add a given account value. This increase in slope is a direct function of the ad multiplier. In the examples of FIG. 3 the cost of programming is similar for all cases, therefore the downward slope of the value line as programming is played is similar in all cases, except apparently in FIG. 3d as discussed below. In FIG. 3c the slope of the value line is vertically upward for the email ads. This indicates that there is no time penalty for receiving these ads. The playtime account increases but the playlist itself is unaffected.

In FIGS. 3a-3c the “minimum account value” is not always zero, as was discussed earlier. In the examples for audio commercials (3a,b) it starts at zero and goes negative. This is so that a user can enjoy at least some programming before ads begin. Of course the start times in FIGS. 3 are arbitrary, a different start time may show a positive account balance. The email ad model of FIG. 3c may have a positive account value from the start as shown. That is because the user's playlist need not be interrupted at any time by ads. An email ad can be sent as the user begins listening in anticipation of the user's enjoyment of programming.

In the ad models of FIGS. 3a-c the value of each ad set is not necessarily the same. In FIG. 3a the value line for COM 4-6 is steeper than for COM 1-3 while the time length of each set is similar. This represents that the sponsors paid more for each time unit of ads 4-6 than for 1-3, for example because of the time of day they were played. COM 7-9 is slightly longer in time than the others, with a slope similar to COM 1-3 indicating a longer commercial break and more account value added than COM 1-3.

In FIG. 3b a much higher value type of commercial is shown. The upward slope of the TCOM ads is very steep, meaning that short ad breaks will substantially increase the playtime account value.

These ads are of high value per time unit because they are well targeted As discussed earlier, the steepness of these ads' value results from the ad multiplier where the user opts in to tracking or providing preference information to the network operator. Note that the average value of the playtime account is gradually increasing in FIG. 3b. This may be incidental because the type of ads and program breaks available happen to lead to more ads than needed for a steady state value. Or the network operator or Station may specifically desire that the playtime account rise to a large positive value so that the user can be awarded benefits such as future free play time, cash, free CD or other benefits. As discussed earlier a large increase in account value could occur if the user responds to an ad or survey questions from a Station, requests extra email ads for benefits, or makes a large e-commerce purchase by means of the Station or its affiliated network. In this case “TCOM”” could be replaced by “Survey” in FIG. 3b, and the value line could be nearly or fully vertical, with a large account value increase, to represent response to a survey by the user. The effect on the playtime account would be similar to receipt of an email ad as in FIG. 3c.

In FIG. 3c one set of email ads, 1,2a-c, is of more value than the second set 3,4. In this example ad 2 is a bundled ad including three separate messages. Ad 2 is therefore more valuable than the other stand-alone ads. Of course other issues can affect the value of an email ad where a single ad could be worth more than several others combined. For example if an email ad includes a response option, such a response by the user could greatly enhance the ad's value. A response would necessarily be later in time than the receipt of the ad. If ad 1 included a response option, and the user sent the response as playlist item “f” was playing, the value line would spike upward near the location of item “f” in FIG. 3c. Then email ads 3 and 4 may not be needed until a future hour. This is an example of free play time resulting from a high value activity of a user. The response to ad 1, or the receipt of any email ad, may be while the user is not receiving any programming. The playtime account will still increase in value and be available for use during a future segment of ad free listening. This would be equivalent to an email ad occurring to the left side of the arbitrary start time in FIG. 3c. The playtime account would hold a positive value in FIG. 3c, while no email ad need be sent during the initial segment, a-k, of the playlist.

In FIG. 3d two types of subscription service are shown. One is a usage-based payment. The other is an unlimited usage fee. The account value scale indicates a “large value” since the payments may be monthly, for example. This contrasts with the ad based payments where incremental payments can occur several times each hour. In the example of FIG. 3d, the payment is at the end of each month, therefore the network operator provides a monetary credit to users. The playtime account thus goes negative as the user plays programming. A fee paid at the start of each month would allow the account to start positive as in FIG. 3c. The downward slope of the value line for programming appears steeper than for FIGS. 3a-c. It is because the time scale is different, month versus hour. The actual cost of programming may be the same for any of the models in FIG. 3. Or the downward slope may change with time as programming items with different time values are played. In FIG. 3d, the playtime account decreases in steps as the user listens to programming. If the user listened continuously the line would also be continuous. But programming is normally accessed in defined sessions; in this case for playlist segments “a-k, l-q”, etc. The cumulative session time is for the programming from “a to mm”. The fee is calculated accordingly. Alternately the fee is for unlimited use. In the example the unlimited fee covers the cost of programming beyond what was actually used since the “no limit” line is below the account value at month's end meaning the account could be depleted further without a deficit. The related fee is the length of the vertical line “subscr. fee” that returns the account to zero. The network operator and Stations would have to carefully consider a fee for unlimited use so that not too many users deplete the account in deficit (relative to costs and profit needs) far below the level of fee imposed. But as with many unlimited use products, some users may subsidize others where the average usage level helps determine the appropriate unlimited use fee.

A subscription play-list would not include any associated commercials or ads. A subscription may enable the user to access commercial free programming on multiple network Stations. Especially if the fee is for unlimited access, such as a set monthly amount, it would be reasonable to expect access to a variety of play-lists and/or Stations. As discussed earlier a “reverse” subscription that paid Playtime Credits into a Playtime Account is also possible to receive benefits for actions while listening to audio programming.

The four models shown in FIG. 3 can be overlaid in combination, with suitable time/value scales used. A fee subscriber may elect to receive email ads to reduce the fee required. An email recipient may elect to receive audio commercials to reduce the quantity of email ads. The network operator or Stations may insist that more than one model be accepted by users to retain a versatile revenue model. For example the network operator or Station may elect to include short commercials directing a user's attention to related email ads. Such email ads can have an increased value, and thus fewer email ads may be sent.

It may be desired to verify that a listener is receiving the email ads. For example the user may have provided the address of an email account that he never reads. In this case the sponsors are getting no value while the user gets valuable programming. One way to verify that the user is reading the email is to occasionally request a response to an audit email from the user. For example the user may be requested to simply reply or to enter a specific character string in a reply message or to enter a predetermined password. This contrasts with conventional email ads including opt-in ads since the present invention provides a valuable and importantly, predictable service for in return for merely receiving email ads. The sponsors and network operator must therefore know that the ads are likely to be received. A specific response to an ad message that benefits the sponsor can serve both to add more value to the playtime account and to verify the receipt of the ad. The network operator may coordinate with sponsors to use response data to generally verify that ads are being received. A simple verification response may not add account value, although many such responses may do so. Every email ad may include a simple verification response prompt, or the ad with the verification prompt may be well identified in its subject line. Accordingly a user need not open every email to find a randomly placed response request. The email account can then be easily verified by the user.

If a user does not respond to a verification ad he may be sent an audio message to encourage reading the ads. The messages may be included in the programming playlist to ensure its receipt, in effect being an audio ad even if the user has requested email ads only. The audio message serves to direct the user's attention to the email ads. As discussed above, a Station may insist that audio ads always be included in the playlists of email ad users. Full audio commercials may eventually be added to the user's playlist, with a possible explanation that the email ads are apparently not being received. If the email account appears inactive through lack of any response, access to commercial free programming may thus be restricted. In this case the network operator is forcing the user to receive audio ads for programming. The audio ads may still employ a multiplier for the user's playtime account if the user has provided the required identifying information. Alternately the user may be billed with a fee for services. A user may then passively choose between opening email ads (or playing through audio ads) and paying fees for programming, where not opening emails will cause a fee assessment, preferably after an advance notice that a fee is imminent.

Email sent from sponsors of network programming will normally include a subject header identifying them as such. For example an email may have a subject line “88Radio: Music offers from Station KXXX” where 88Radio is an exemplary name for the affiliate network operator. The user can know that receiving emails with 88Radio in the subject title is reliably paying for programming, in contrast with spam or conventional opt-in email that pays for nothing. Further it is likely that the network operator will provide at least some control over the type of email ads that are sent, ensuring that “88Radio” brand ads will maintain a certain level of quality. As a result email ads according to the invention will possess a brand identity. Since the emails of the present invention serve to pay for well-identified services rendered they will likely be less offensive than conventional email ads. Note that if the user were to purchase music as a result of the above email ad additional playtime credits would be added to his playtime account, where his playtime account identity is known from the cookie or other identifier that he opted to allow.

To prevent others from claiming the brand identity of the email ads a security software routine in a user's browser or email receiving device may filter or authenticate emails from network or Station sponsors. Such a filter may search for secure code within legitimate sponsor emails so that only authorized emails are allowed through with “88Radio” in the subject. In this manner spammers cannot use the network identity to pretend to be paying for access to network programming.

The filter within the email program or email device may search incoming emails for a keyword in the subject, “88Radio” in the example. If the keyword is present the filter will scan further within the code comprising the email for an authorization element such as a password or other character string. Both the filter and the authorizing element may be provided by the network operator or associated agent to users who opt-into email ads. The authorizing element may be encrypted and/or not visible to the user, and decrypted by the email program or device, so that it cannot be easily duplicated by spammers or others. The authorizing element and filter may allow for periodic changes in the password or character string as directed by the network operator or its agents. An email ad that contains the keyword, but does not contain a valid authorizing element will be rejected, or optionally flagged, by the filter. The filtering procedure may occur after the email is opened if this facilitates scanning of the email by the filter according to the inventon. In this case a non-authentic email can be deleted or flagged by the filter after the email is opened. The user can be assured that branded emails are targeted and relevant to his profile if the profile was submitted to the network operator, and that the email ads are actually paying for services.

If a user has elected to allow tracking, his listening habits and any web browsing or e-commerce activities while listening to network sites (and possibly off-network sites as well) will be tracked using well-known methods such as browser cookies. According to the invention this process is not forced upon the user in the conventional way; rather the user receives more valuable programming (meaning reduced commercial interruptions and/or premium programming) by specifically allowing tracking. When the user allows tracking, the value of his Playtime Account Multiplier rises above 1 such that Playtime Credits entered into the Playtime Account may be multiplied and the number of Credits in the Account correspondingly increased. By limiting an identity to cookies in a browser the user need not enter a password or have an identified device to receive valuable programming.

However if a user wants even fewer or no commercials he will need to provide more identifying information initially and possibly during use of Station programming to increase the value of ads he receives Personal preference data may be requested as an initial registration procedure. Subsequently a password, device identifier or equivalent identifier would be requested by the network operator to use the various personal channels of network Stations. Similarly an opt-in email address would be associated with an access password or equivalent software or hardware identifier.

For some types of programming, such as video service equivalent to cable TV or video on demand, special audio broadcasts, audio books, spoken advice or personalized information, the cost and value per unit time of the service may be too great to be paid regularly by only the email ad method of the invention. For example the quantity of email ads may need to be so large that the user would object to them and the value of each ad would decline. In this case the email method of the invention may be used to pay for portions of programming service with remaining portions paid by commercials, fees or other beneficial activities such as purchases and survey responses. The commercials may be separate in subject or related to the email ads. For example viewing a pay per view movie could be paid for from a user's playtime account and trigger sending email ads to a user's associated email address. If a periodic email quota is used up the playtime account may trigger commercials or a fee request if the account is at a minimum value. Use of just email payment for pay per view could be limited to a specified number of movies per month since as discussed, the value to sponsors of excess email ads will decline.

Alternately a regular quantity of email ads may be sent in return for basic video service or for one movie channel for example. In this case regular email ads are used to enhance an existing service. For these high value services it will be important to verify receipt of the email ads as discussed earlier. A playtime account may be used for combinations of both audio and video programming where credits and debits occur as a result of both activities.

If the tuner provided by the network operator, or used with network Stations, is a physical device such as a car or personal player the payment method of the present invention may be used.

The audio hardware devices and systems used in conjunction with the present invention may be personal computers, MP3 players, audio-enabled cellular telephones such as the Mobile Interactive Radio disclosed by Bottom in U.S. Pat. No. 6,014,569 and devices such as those offered by Sonicbox (www.sonicbox.com) and Kerbango (www.kerbango.com).

Typically a car or personal player is used primarily by one person. The user may initially provide identifying information by, for example, registering the device with the network operator.

An identifier may be stored in the device for use with network Stations. Audio commercials received by the device will be targeted to the user if he has provided preference information upon registering. An unidentified device may be used to listen to network affiliated Stations, although it will normally receive more commercials as described earlier. No commercials will be received if the user has registered by subscription. Email ads do not need to be received at the end user player device, therefore one recipient email account may enable a single associated identified device or identified user of a device to receive valuable programming. A device registered to a single user may be used by others if it is not password protected, where the registered user pays for others' use of the device if payment is by receipt of email ads or subscription fees.

If a player device is used by more than one person the current user can enter a name or other ID to access valuable programming. However he may also be identified substantially automatically. In all cases it is assumed that one or more users of a device have opted-in to being identified in return for receiving valuable programming. The users have performed some initial procedures to set up user profiles, by for example setting up a benefit or playtime account. To automatically identify different users of the same device a form of tracking may be used where the type of programming preferred by each user is compared to what is currently being played, A current user can then be correlated to currently playing programs. The user profile may be as simple as preferred local TBR stations, or typical listening times. Well-targeted ads can then be sent to the current listener. If the ads are in the form of email, the emails can be sent to each user's respective address in proportion to each user's listening time. If the network operator or other ad provider is not certain which registered user is listening the current user can be queried for a response through an input feature of the player device. If the current user is unknown or he behaves similarly to the primary registered user, ads can be sent as if the primary user were listening. In this case, as above, the primary user is paying for another person's use of the device when the primary user receives email ads or pays a fee as a result of another person's use of the device. The current user naturally pays if audio ads in the playlist are used.

The status of the playtime account may be tracked by a server controlled by a Station or the network operator. In this case the network operator may communicate with the user's tuner where the tuner contains the user's account identifier. A tuner is a device or program for selecting, modifying and/or playing programming. The tuner may also be a device or routine for tracking a value of services. A tuner that performs both functions may be supplied by the network operator. The network operator logs the amount of time the tuner is used and/or the value of programming that has been delivered to it. The user's playtime account is debited accordingly. Alternately the playtime account status is kept up to date within the tuner whereby debits against the account are made internally by the tuner or associated device. The network operator would load a routine into the user's tuner to control debit actions. If the account is internal to a tuner all other tuners, or devices with tuners, that use the same account would need to be updated together. The user's tuners are in effect distributed among different nodes of the Internet and kept synchronized by, for example, the network operator or by each other through the Internet or a data link. A device containing a tuner controlled account becomes a self-contained unit of value for receiving valuable programming from the affiliate network. The value tracking may in fact occur in a specific purpose area of a user's device separate from a selecting, modifying or playiong feature. But debits to a playtime account must normally be correlated to receipt of programming by use of a tuner.

Payment for programming can occur at a device, time or place separate from where use of programming is tracked. For example according to the invention email ads can be received separately from a tuner or playing activity. The value of emails ads received by a user's email device, or fees paid etc., can be tracked by the network operator where the credits are then loaded into a user's tuner or tuners. Or the credits are loaded into a network operator controlled server or other account tracking system where the same tracking system may provide for debiting the user's playtime account.

1. A system of payment for the receipt of programming by a user where the programming is delivered by means of a data network, the system comprising:
a playtime account assigned by a network operator to at least one of a user and a device, the playtime account containing playtime credits that serve at least partially to pay for receipt of programming;
playtime credits being added to the playtime account as activities attributed to the user that are beneficial to the network operator occur, the activities being prompted by the network operator in response to the receipt of programming by the user.

2. The payment system of claim 1 wherein, in lieu of presenting commercial advertising accompanying the programming delivered to the user, the network operator withdraws playtime credits from the user's playtime account, and when resulting programming contains reduced accompanying commercial advertising, the programming comprises valuable programming.

3. The payment system of claim 2, werein the commercial advertising comprises at least one of audio and video ad inserts within the programming.

4. The payment system of claim 2 wherein the commercial advertising comprises display ads presented on a device that is used to play programming.

5. The payment system of claim 2 wherein playtime credits are deducted from the playtime account at least partially in proportion to the quantity of valuable programming received by the user.

6. The payment system of claim 1 wherein the beneficial activities include the receipt of advertising to an email account of the user.

7. The payment system of claim 1 wherein the beneficial activities comprise completion of a survey by a user.

8. The payment system of claim 1 wherein the beneficial activities comprise the receipt by the user of advertising sent to an email account of the user.

9. The payment system of claim 1 wherein, in lieu of presenting commercial advertising accompanying the programming delivered to the user, the network operator sends email ads to the user.

10. The payment system of claim 8 wherein the email ads are sent at least partially in proportion to the value of programming that has been received by the user.

11. The payment system of claim 1 wherein network operator maintains the user's playtime account on behalf of a third party.

12. The payment system of claim 1 wherein a tuner is used to control the receipt of programming, the tuner includes an identity of at least one of the user and device, and playtime credits are withdrawn from the user's playtime account as the tuner is used to receive programming from Stations affiliated in a network that is managed by the network operator.

13. The payment system of claim 1 wherein a minimum allowable quantity of playtime credits in a user's playtime account is established by the network operator, and when the user has caused the playtime account to be depleted to the minimum allowable quantity of playtime credits, activities beneficial to the network operator occur.

14. The payment system of claim 13, wherein the beneficial activities include the receipt of advertising to an email account of the user.

15. A system of payment for the receipt of programming by a user where the programming is delivered by means of a data network, the system comprising:
commercial advertising sent to the user, where a quantity of advertising that is sent to the user with respect to a quantity of programming that is received by the user decreases in proportion to an extent to which the user selects to be identified to a network operator.

16. The payment system of claim 15, wherein the user is minimally identified to the network operator unless the user selects to be further identified to the network operator.

17. A method of payment for the receipt of programming by a user where the programming is delivered by means of a data network, the method comprising:
a user being offered an opportunity to elect to receive advertising that benefits a network operator, the advertising being in the form of email messages sent to an email account of the user;
the network operator promising that in return for the user receiving the email messages, the user will be entitled access to well identified programming services including at least one play-list of an established value;
the user receiving the email messages in response to a user's request to access programming services.

18. The method of claim 17, wherein a play-list includes a value that is established by a cash cost of a further electable method of obtaining entitlement to access the play-list.

19. The method of claim 18, wherein the further electable method includes paying a subscription fee.

20. The method of claim 17, wherein the user has elected a method to pay for permission from the network operator to access programming services, the at least one play-list comprises additional premium programming services, and the network operator causes the user to receive email advertising in response to the user's receipt of the additional premium programming.

21. The method of claim 17, wherein the user is offered an opportunity to access a trial play-list during a trial period during which the user receives no email advertising in response to receiving the trial play-list, and the trial play-list comprises a predetermined length loop of programming containing a substantially unchanging selection of programs.

22. The method of claim 17, wherein the email messages include a subject header that identifies the email messages as serving to pay for access to the at least one play-list.

23. The method of claim 17, wherein the network operator monitors a user's reaction to email messages that are sent, and if network operator detects no reaction by the user to a sequence of email messages, a further message is inserted amongst the programming.

24. The method of claim 23, wherein the further message comprises a request that the user respond to the email messages.

25. The method of claim 23, wherein the further message comprises a commercial advertisment accompanying the programming.

26. The method of claim 17, wherein the email messages are received by the user in a separate time, space and situation from the receipt of the programming.

27. The method of claim 26, wherein the programming and commercial advertisment is received by means of a tuner, and the email messages are received on a device that is separate from the tuner.

28. The mehod of claim 26, wherein the email messages are sent at a time that is different from the time during which the programming, for which the email messages serve to pay, is received.
